(19) United States
(12) Patent Application Publication
(10) Pub. No.: US 2007/0047671 A1
(43) Pub. Date: Mar. 1, 2007

(54) Frequency tracking and channel estimation in orthogonal frequency division multiplexing systems

(75) Inventor: Hung-Kun Chen, Hsinchu (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Mediatek Inc.

(21) Appl. No.: 11/211,285

(22) Filed: Aug. 25, 2005

(51) Int. Cl. H04L 27/06

(52) U.S. Cl. 375/326

(57) ABSTRACT

A mechanism for frequency tracking and channel estimation in multi-carrier systems. First, two training symbols are pre-compensated for an effect of frequency offset. Then an average of the two pre-compensated symbols is calculated. Meanwhile, a correlation between the two pre-compensated second symbols is evaluated by performing a differential operation. By means of a tracking loop, a frequency tracking value is calculated from the correlation and a loop coefficient. After that, the average of the two pre-compensated symbols is further compensated with a fine frequency offset estimate derived from the frequency tracking value. Accordingly, a channel response is estimated by performing a Fourier transform on the compensated average.

### BACKGROUND

1. Field of the Invention

The invention relates to communications systems, and more particularly to a scheme for frequency tracking and channel estimation in Orthogonal Frequency Division Multiplexing (OFDM) systems.

2. Description of the Related Art

With the rapidly growing demand for cellular, mobile radio and other wireless transmission services, there has been an increasing interest in exploiting various technologies to provide reliable, secure, and efficient wireless communications. Orthogonal Frequency Division Multiplexing (OFDM) is well known as a high spectrally efficient transmission scheme capable of dealing with severe channel impairment encountered in a mobile environment. OFDM was previously adopted for wireless local area network (WLAN) applications as part of the IEEE 802.11a standard in the 5 GHz frequency band. Furthermore, the IEEE 802.11g standard 5 approved in June of 2003 also adopted OFDM as a mandatory part for a further high-speed physical layer (PHY) extension to the 802.11b standard in the 2.4 GHz band.

The basic idea of OFDM is to divide the available spectrum into several sub-channels (subcarriers). By making all sub-channels narrowband, they lo experience almost flat fading, which makes equalization very simple. In order to obtain a high spectral efficiency, the frequency responses of the sub-channels overlap and are orthogonal. This orthogonality can be completely maintained by introducing a guard interval, even though the signal passes through a time-dispersive channel. A guard interval (GI) is a 15 copy of the last part of an OFDM symbol, pre-appended to the transmitted symbol. This plays a decisive role in avoiding inter-symbol and inter-carrier interference.

OFDM can largely eliminate the effects of inter-symbol interference (ISI) for high-speed transmission in highly dispersive channels by separating a single high speed bit stream into multiple of much lower speed bit streams each modulating a different subcarrier. However, OFDM is known to be vulnerable to synchronization errors due to the narrow spacing between subcarriers. In general, mismatch between transmitter and receiver oscillators contributes a non-zero carrier frequency offset in a received OFDM signal. Transient behavior of the frequency synthesizer is another source of the frequency offset. OFDM signals are highly susceptible to the frequency offset which causes a loss of orthogonality between the OFDM subcarriers and results in inter-carrier interference (ICI) and bit error rate (BER) deterioration of the receiver. Yet another concern is the channel frequency response. An efficient estimation of channel is necessary before the demodulation OFDM signals since the radio channel is frequency selective and time-varying for wideband mobile communications systems. Therefore, what is needed is a mechanism for rapid frequency acquisition in OFDM receives. It is also desirable to provide an OFDM receiver capable of joint frequency offset tracking and channel estimation.

### SUMMARY

The present invention is generally directed to a scheme for frequency tracking and channel estimation in multi-carrier systems such as OFDM receivers. According to one aspect of the invention, the first step of a channel estimation method is pre-compensation of two training symbols in a received preamble for an effect of frequency offset. Next, an average of the two pre-compensated symbols is calculated and the average is further compensated with a fine frequency offset estimate. A channel response can be virtually estimated by performing a Fourier transform on the compensated average.

According to another aspect of the invention, a method of frequency tracking in multi-carrier systems is proposed. First, two training symbols in a received preamble are individually pre-compensated for an effect of frequency offset. Then, a correlation between the two pre-compensated symbols is evaluated by performing a differential operation. By means of a tracking loop, a frequency tracking value can be calculated from the correlation and a loop coefficient.

According to yet another aspect of the invention, a multi-carrier receiver is set forth in the disclosure. The multi-carrier receiver comprises a frequency compensator, a differential operator, and a frequency tracking unit. The frequency compensator is responsible for pre-compensating two training symbols in a received preamble for an effect of frequency offset. The differential operator is responsible for evaluating a correlation between the two compensated symbols. The frequency tracking unit is responsible for calculating a frequency tracking value based on the correlation and a loop coefficient. Preferably, the multi-carrier receiver of the invention also comprises a channel estimator to calculate an average of the two pre-compensated symbols, compensate the average with a fine frequency offset estimate, and then estimate a channel response by performing a Fourier transform on the compensated average.

### BRIEF DESCRIPTION OF THE DRAWINGS

The present invention will be described by way of exemplary embodiments, but not limitations, illustrated in the accompanying drawings in which like references denote similar elements, and in which:

FIG. 1 is a structural diagram of a PLCP preamble described in the IEEE 802.11a/g standard;

FIG. 2 is a block diagram of a multi-carrier receiver according to an embodiment of the invention; and

FIG. 3 is a detailed block diagram of the multi-carrier receiver according to an embodiment of the invention.

### DETAILED DESCRIPTION

Reference throughout this specification to “one embodiment” or “an embodiment” indicates that a particular feature, structure, or characteristic described in connection with the embodiments is included in at least one embodiment of the present invention. Thus, the appearance of the phrases “in one embodiment” or “an embodiment” in various places throughout this specification is not necessarily all referring to the same embodiment. Furthermore, the particular features, structures, or characteristics may be combined in one or more embodiments. As to the accompanying drawings, it should be appreciated that not all components necessary for a complete implementation of a practical system are illustrated or described in detail. Rather, only those components necessary for a thorough understanding of the invention are illustrated and described. Furthermore, components which are either conventional or may be readily designed and fabricated in accordance with the teachings provided herein are not described in detail.

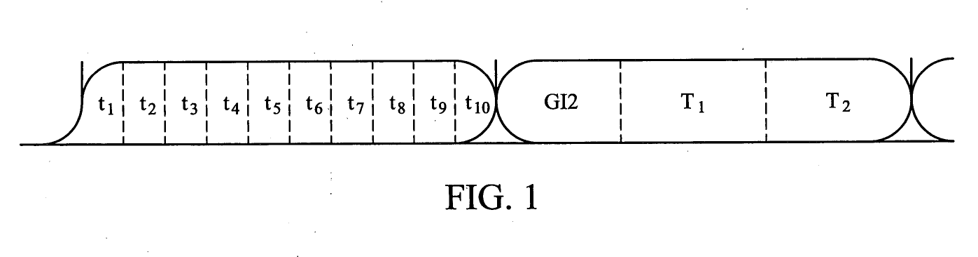

The present invention will now be described in the context of the use of OFDM for communication, although the present invention is not limited to OFDM. The present invention is also described with reference to a wireless communication system that conforms to the IEEE 802.11a/g standard. According to the invention, the communication system need not be wireless and the conformant 802.11a/g transceiver referred to herein is merely an example. The IEEE 802.11a/g standard requires a transmitter to provide a data frame with a PLCP preamble field for synchronization at the receiving end. FIG. 1 shows the PLCP preamble, where t₁ to t₁₀ denote short training symbols, T₁ and T₂ denote long training symbols, and GI2 denotes a guard interval for the long training sequence. Typically, the first ten symbols t₁ to t₁₀ are used for AGC convergence, diversity selection, timing acquisition, and coarse frequency acquisition in a receiver. The next two symbols T₁ and T₂, preceded by GI2, are used for channel estimation and fine frequency acquisition in the receiver. The PLCP preamble is followed by the SIGNAL field and DATA (not shown). The dashed boundaries in the figure denote repetitions due to the periodicity of the inverse Fourier transform.

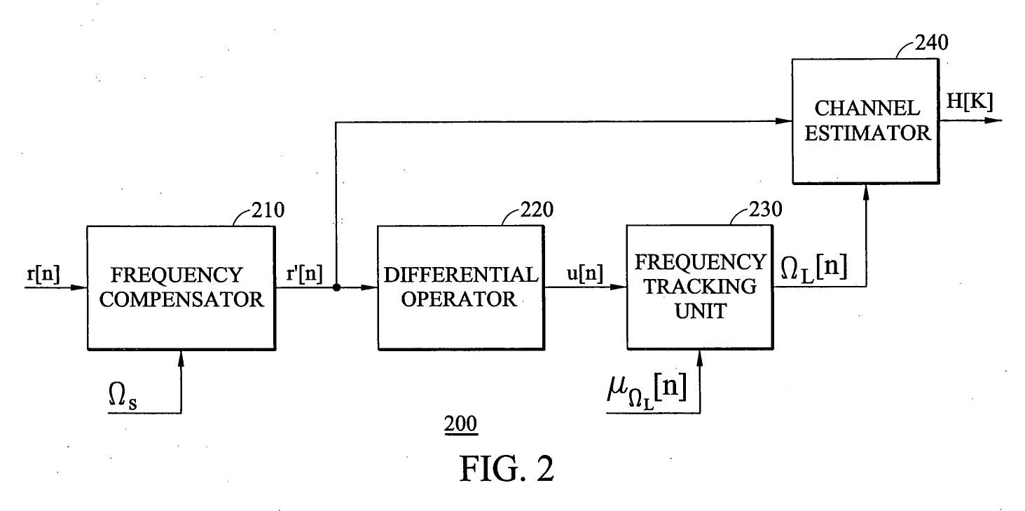

In a conformant 802.11a/g system, an OFDM symbol is modulated onto a number of subcarriers by applying an N-point inverse Fast Fourier Transform (FFT) with N=64. Out of the 64 narrowband subcarriers, only 52 carry information and the others are zeros. Referring to FIG. 2, a receiver 200 of the invention comprises a frequency compensator 210, a differential operator 220, a frequency tracking unit 230 and a channel estimator 240. Prior to entering the frequency compensator 210, a received signal, r, has been subjected to the coarse frequency acquisition via the first ten short symbols in its preamble. After the ten short symbols, two long training symbols are sent along with the coarse frequency offset estimate to the frequency compensator 210 where the effect of frequency offset is pre-compensated for. Here the received signal in the time domain is denoted by a sequence of discrete samples, {r[n]}, in which r[n] is 15 complex-valued and indicates a sample of {r[n]} at time instant n. Then the first long training symbol is of the form {r[n]; 0≦n≦N−1} and the second long training symbol is of the form {r[n]; N≦n≦2N−1}, where N=64 in the example of the conformant 802.11a/g system. Note that the coarse frequency offset estimate is denoted by Ω_{S}. The pre-compensated version of the received signal, r′[n], is sent to both the differential operator 220 and the channel estimator 240. The differential operator 220 is responsible for evaluating a correlation, u[n], between the two pre-compensated training symbols r′[n] and r′[n−N]. The frequency tracking 5 unit 230 accepts the correlation u[n] and generates a frequency tracking value per sample. Specifically, the frequency tracking value, Ω_{L}[n], can be calculated in accordance with the correlation u[n] and a loop coefficient μ_{Ω}_{_{L}}[n] by means of a tracking loop. Further, a fine frequency offset estimate can be derived from the frequency tracking value Ω_{L}[n]. The channel estimator 240 first calculates an average of the two pre-compensated training symbols r′[n] and r′[n−N], compensates this average with the fine frequency offset estimate, and then estimates a frequency-domain channel response, H[k], by performing a Fourier transform on the compensated average.

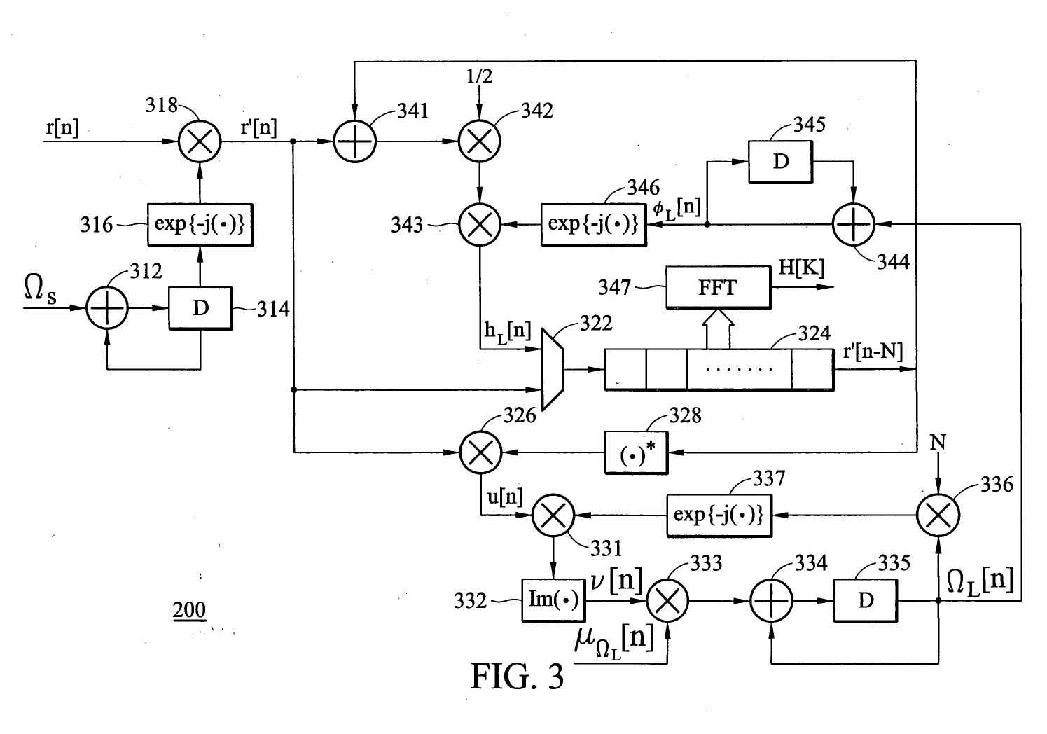

The innovative receiver 200 is now described in detail with reference to FIG. 3. As depicted, the coarse frequency offset estimate Ω_{S} is applied to an adder 312 and a delay unit 314, e.g. a D flip-flop, so as to yield a discrete value of Ω_{S}·n. A subsequent block 316 is employed to yield e^{-jΩ}^{ₛ}ⁿ, a complex exponential with a frequency that is the negative of Ω_{S}. The received signal r[n] is applied to a multiplier 318 where the two long training symbols are multiplied by e^{-jΩ}^{ₛ}ⁿ. Thus, the pre-compensated version of the two long training symbols can be shown to have the form:
r′[n]=r[n]e^{-jΩ}^{ₛ}ⁿ, n=0,1,2, . . . ,2N−1
where
the pre-compensated version of the first long training symbol is given by {r′[n]; 0≦n≦N−1}, and
the pre-compensated version of the second long training symbol is given by {r′[n]; N≦n≦2N−1}.

Initially, a multiplexer 322 selects the first pre-compensated symbol to enter a first-in-first-out (FIFO) buffer 324, where the length of the FIFO buffer 324 is preferably equal to N. The FIFO buffer 324 provides a lagged version of the first pre-compensated symbol, r′[n−N], serially to the following block 328 in which complex conjugation is performed. When the second pre-compensated symbol r′[n] appears, a multiplier 326 is employed to calculate the product of r′[n] and (r′[n−N])*, where n=N, N+1, . . . , 2N−1, and superscript * denotes complex conjugation. As such, a differential operation is performed on a one-by-one basis to yield the correlation between the two pre-compensated symbols as follows:
u[n]=r′[n]·(r′[n−N]), n=N+1, . . . ,2N−1.

The correlation u[n] is then applied to a tracking loop modeled with a set of equations:

$$\begin{matrix}v [ n ] = Im ( u [ n ] {ⅇ}^{- j {Ω}_{L} [ n ] \cdot N} ) \\ {Ω}_{L} [ n + 1 ] = {Ω}_{L} [ n ] + {μ}_{{Ω}_{L}} [ n ] \cdot v [ n ]\end{matrix} , n = N , N + 1 , … , 2 N - 1$$

where Ω_{L}[N]=0, Im(·) denotes the imaginary part of a complex number, and the loop coefficient μ_{Ω}_{_{L}}[n] is set to ¼, ⅛, 1/16, or 1/32, depending on index n. It can be seen in FIG. 3 that the tracking loop is implemented with multipliers 331, 333 and 336, block 332, adder 334, delay unit 335, and block 337.

Still referring to FIG. 3, an adder 341 accepts r′[n] at its one input and accepts r′[n−N] at another input. When the second pre-compensated symbol arrives, the adder 341 calculates the sum of r′[n] and r′[n−N] on a one-by-one basis, where n=N, N+1, . . . , 2N−1. The output of the adder 341 is fed to a multiplier 342 where it is multiplied by ½, and the average of the two pre-compensated training symbols is obtained accordingly. Additionally, the frequency tracking value Ω_{L}[n] is applied to an adder 344 working conjunction with a delay unit 345, thus yielding the fine frequency offset estimate, φ_{L}[n], as follows:
φ_{L}[n]=φ_{L}[n−1]+φ_{L}[n], n=N+1, . . . , 2N−1
where φ_{L}[N−1]=0. A subsequent block 346 is employed to yield e^{-jφ}^{_{L}}^{[n]}, a complex exponential with a phase that is the negative of φ_{L}[n]. Next, a multiplier 343 receives the output of the multiplier 342 and the output of the block 346 to perform multiplication. In this way, the average of the two pre-compensated training symbols is further compensated for the fine frequency offset estimate. Therefore, the compensated average, h_{L}[n], is given by:

$${h}_{L} [ n ] = \frac{{r}^{′} [ n - N ] + {r}^{′} [ n ]}{2} {ⅇ}^{- j {ϕ}_{L} [ n ]} , n = N , N + 1 , … , 2 N - 1.$$

At this time, the multiplexer 322 allows h_{L}[n] to serially enter the FIFO buffer 324. When all samples of the compensated average h_{L}[n] are kept in the FIFO buffer 324, they are ready for transformation into the frequency domain. In one embodiment, an FFT block 347 receives the compensated average h_{L}[n] from the FIFO buffer 324 and generates the frequency-domain channel response H[k] by taking an N-point Fast Fourier Transform (FFT).

In view of the above, the receiver 200 of the present invention provides a faster response with respect to the frequency drift in the preamble portion of a data frame. The receiver 200 may be implemented with any combination of logic in an application specific integrated circuit (ASIC) or firmware. Although the FFT is mentioned in the above discussion, it should be clear to those skilled in the art that the Discrete Fourier Transform (DFT) is also applicable to the present invention since the FFT is an efficient scheme for computing the DFT. Therefore, DFT and FFT are herein interchangeable terms according to the principles of the lo invention. Furthermore, since the Fourier transforms (FT) and inverse Fourier transforms (IFT) are symmetrical operations, it will be clear to one of ordinary skill in the art that a scaled time-domain signal may be generated from the frequency-domain signal by simply performing a FT on the data, rather than performing an IFT.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method of channel estimation in multi-carrier systems, comprising:
(a) pre-compensating a first and second symbol for an effect of frequency offset;
(b) calculating an average of the first and the second pre-compensated symbols;
(c) compensating the average with a fine frequency offset estimate; and
(d) estimating a channel response by performing a Fourier transform on the compensated average.

2. The method of claim 1 wherein the first and the second symbols each comprise N number of samples, and step (a) compensates the first and the second symbols with a coarse frequency offset estimate based on the following equation:
r′[n]=r[n]e^{-jΩ}^{ₛ}ⁿ, n=0,1,2, . . . , 2N−1
where
Ω_{S} denotes the coarse frequency offset estimate,
n denotes a time instant,
r[n] denotes a sample of {r[n]} at time instant n, and
the first symbol is of the form {r[n]; 0≦n≦N−1},
the second symbol is of the form {r[n]; N≦n≦2N−1},
the first pre-compensated symbol is given by:
{r′[n]; 0≦n≦N−1}, and
the second pre-compensated symbol is given by:
{r′[n]; N≦n≦2N−1}.

3. The method of claim 2 wherein step (c) comprises:
evaluating a correlation between the first and the second pre-compensated symbols by performing a differential operation;
calculating a frequency tracking value by a tracking loop modeled with a set of equations as follows:
$$\begin{matrix}v [ n ] = Im ( u [ n ] {ⅇ}^{- j {Ω}_{L} [ n ] \cdot N} ) \\ {Ω}_{L} [ n + 1 ] = {Ω}_{L} [ n ] + {μ}_{{Ω}_{L}} [ n ] \cdot v [ n ]\end{matrix} , n = N , N + 1 , … , 2 N - 1$$
where
Im(·) denotes the imaginary part of a complex number,
u[n] denotes the correlation between the first and the second, pre-compensated symbols,
μ_{Ω}_{_{L}}[n] denotes a loop coefficient, and
Ω_{L}[n] denotes the frequency tracking value in which Ω_{L}[N]=0; and
deriving the fine frequency offset estimated from the frequency tracking value.

4. The method of claim 3 wherein the fine frequency offset estimate, φ_{L}[n], is given by:
φ_{L}[n]=φ_{L}[n−1]+Ω_{L}[n], n=N, N+1, . . . ,2N−1
where
φ_{L}[N−1]=0.

5. The method of claim 4 wherein the compensated average, h_{L}[n], is given by:
$${h}_{L} [ n ] = \frac{{r}^{′} [ n - N ] + {r}^{′} [ n ]}{2} {ⅇ}^{- j {ϕ}_{L} [ n ]} , n = N , N + 1 , … , 2 N - 1.$$

6. The method of claim 3 wherein the correlation between the first and the second pre-compensated symbols is evaluated as follows:
u[n] r′[n]·(r′[n−N])*, n=N,N+1, . . . ,2N−1
where
superscript * denotes complex conjugation.

7. The method of claim 3 wherein the first and the second symbols are two long training symbols in a PLCP preamble field dictated by the IEEE 802.11a standard, and the loop coefficient μ_{Ω}_{_{L}}[n] is set to ¼, ⅛, 1/16, or 1/32, depending on index n.

8. The method of claim 3 wherein the first and the second symbols are two long training symbols in a PLCP preamble field dictated by the IEEE 802.11g standard, and the loop coefficient μ_{Ω}_{_{L}}[n] is set to ¼, ⅛, 1/16, or 1/32, depending on index n.

9. A method of frequency tracking in multi-carrier systems, comprising:
pre-compensating a first and second symbol for an effect of frequency offset;
evaluating a correlation between the first and the second pre-compensated symbols by performing a differential operation; and
calculating a frequency tracking value by a tracking loop using the correlation and a loop coefficient.

10. The method of claim 9 wherein the first and the second symbols each comprise N number of samples, and the pre-compensating step compensates the first and the second symbols with a coarse frequency offset estimate based on the following equation:
r′[n]=r[n]e^{-jΩ}^{ₛ}ⁿ, n=0,1,2, . . . ,2N−1
where
Ω_{S} denotes the coarse frequency offset estimate,
n denotes a time instant,
r[n] denotes a sample of {r[n]} at time instant n, and
the first symbol is of the form {r[n]; 0≦n≦N−1},
the second symbol is of the form {r[n]; N≦n≦2N−1},
the first pre-compensated symbol is given by:
{r′[n];0≦n≦N−1},
the second pre-compensated symbol is given by:
{r′[n];N≦n≦2N−1}.

11. The method of claim 10 wherein the correlation between the first and the second pre-compensated symbols is evaluated by:
u[n]=r′[n]*(r′[n−N])*, n=N,N+1, . . . ,2N−1
where
superscript * denotes complex conjugation.

12. The method of claim 11 wherein the tracking loop is model with a set of equations, as follows:
$$\begin{matrix}v [ n ] = Im ( u [ n ] {ⅇ}^{- j {Ω}_{L} [ n ] \cdot N} ) \\ {Ω}_{L} [ n + 1 ] = {Ω}_{L} [ n ] + {μ}_{{Ω}_{L}} [ n ] \cdot v [ n ]\end{matrix} , n = N , N + 1 , … , 2 N - 1$$
where
Im(·) denotes the imaginary part of a complex number,
u[n] denotes the correlation between the first and the second pre-compensated symbols,
μ_{Ω}_{_{L}}[n] denotes the loop coefficient, and
Ω_{L}[n] denotes the frequency tracking value in which Ω_{L}[N]=0.

13. The method of claim 12 further comprising the step of deriving a fine frequency offset estimate, X [n], from the frequency tracking value, by:
φ_{L}[n]=φ_{L}[n−1]+Ω_{L}[n], n=N,N+1, . . . ,2N−1
where
φ_{L}[N−1]=0.

14. The method of claim 12 wherein the first and the second symbols are two long training symbols in a PLCP preamble field dictated by the IEEE 802.11a standard, and the loop coefficient μ_{Ω}_{_{L}}[n] is set to ¼, ⅛, 1/16, or 1/32, depending on index n.

15. The method of claim 12 wherein the first and the second symbols are two long training symbols in a PLCP preamble field dictated by the EEBE 802.11g standard, and the loop coefficient μ_{Ω}_{_{L}}[n] is set to ¼, ⅛, 1/16, or 1/32, depending on index n.

16. A multi-carrier receiver comprising:
a frequency compensator pre-compensating a first and second symbol for an effect of frequency offset;
a differential operator evaluating a correlation between the first and the second compensated symbols; and
a frequency tracking unit calculating a frequency tracking value based on the correlation and a loop coefficient.

17. The receiver of claim 16 wherein the first and the second symbols each comprise N number of samples, and the frequency compensator compensates the first and the second symbols with a coarse frequency offset estimate based on the following equation:
r′[n]=r[n]e^{-jΩ}^{ₛ}ⁿ, n=0,1,2, . . . ,2N−1
where
Ω_{S} denotes the coarse frequency offset estimate,
n denotes a time instant,
r[n] denotes a sample of {r[n]} at time instant n, and
the first symbol is of the form {r[n]; 0≦n≦N−1},
the second symbol is of the form {r[n]; N≦n≦2N−1},
the first pre-compensated symbol is given by:
{r′[n];0≦n≦N−1},
the second pre-compensated symbol is given by:
{r′[n];N≦n≦2N−1}.

18. The receiver of claim 17 wherein the differential operator evaluates the correlation between the first and the second pre-compensated symbols from
u[n]=r′[n]·(r′[n−N])*, n=N,N+1, . . . ,2N−1
where
superscript * denotes complex conjugation.

19. The receiver of claim 18 wherein the frequency tracking unit comprises a tracking loop modeled with a set of equations, as follows:
$$\begin{matrix}v [ n ] = Im ( u [ n ] {ⅇ}^{- j {Ω}_{L} [ n ] \cdot N} ) \\ {Ω}_{L} [ n + 1 ] = {Ω}_{L} [ n ] + {μ}_{{Ω}_{L}} [ n ] \cdot v [ n ]\end{matrix} , n = N , N + 1 , … , 2 N - 1$$
where
Im(·) denotes the imaginary part of a complex number,
u[n] denotes the correlation between the first and the second pre-compensated symbols,
μ_{Ω}_{_{L}}[n] denotes the loop coefficient, and
Ω_{L}[n] denotes the frequency tracking value in which Ω_{L}[N]=0.

20. The receiver of claim 19 further comprising:
a channel estimator calculating an average of the first and the second pre-compensated symbols, compensating the average with a fine frequency offset estimate, and estimating a channel response by performing a Fourier transform on the compensated average;
wherein the fine frequency offset estimate, φ_{L}[n], is derived from:
φ_{L}[n]=φ_{L}[n−1]+Ω_{L}[n], n=N,N+1, . . . ,2N−1
where φ_{L}[N−1]=0;
wherein the compensated average, h_{L}[n], is given by:
$${h}_{L} [ n ] = \frac{{r}^{′} [ n - N ] + {r}^{′} [ n ]}{2} {ⅇ}^{- j {ϕ}_{L} [ n ]} , n = N , N + 1 , … , 2 N - 1.$$
